(19) United States
(12) Patent Application Publication
(10) Pub. No.: US 2005/0062837 A1
(43) Pub. Date: Mar. 24, 2005

(54) Method and apparatus for controlling a laser scanning unit

(76) Inventor: Hyung-Soo Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/935,132

(22) Filed: Sep. 8, 2004

(30) Foreign Application Priority Data
Sep. 18, 2003 (KR) 2003-64852

(51) Int. Cl. B41J 2/455

(52) U.S. Cl. 347/233; 347/238

(57) ABSTRACT

Apparatus and method for controlling a laser scanning unit which scans beams on a photosensitive drum to form an electrostatic latent image corresponding to an image signal synchronized with a reference clock. The apparatus comprise a first clock generating unit for dividing the reference clock signal according to a setting value applied externally to generate a first clock signal; a correction value calculating unit for dividing a section on the photosensitive drum into a predetermined number according to an external value, varying the number of the first clock signal assigned per unit clock of the divided respective sections, and calculating the clock frequencies of the respective sections based on the varied number; and a second clock signal generating unit for generating a clock signal corresponding to the clock calculated frequency calculated to replace the generated clock with the reference clock signal.

### CROSS-REFERENCE TO RELATED APPLICATIONS

This application claims the benefit under 35 U.S.C. 119(a) of Korean Patent Application No. 2003-64852 filed Sep. 18, 2003, in the Korean Intellectual Property Office, the entire content of which is incorporated herein by reference.

### BACKGROUND OF THE INVENTION

1. Field of the Invention

The present invention relates to a laser scanning unit. More particularly, the present invention relates to an apparatus and a method for controlling a laser scanning unit wherein an error associated with an electrostatic latent image, which is formed by the beam scanned from the laser scanning unit onto a photosensitive drum, can be corrected and minimized.

2. Description of the Related Art

Generally, a laser printer forms an image from a laser beam emitted from a laser diode onto a photosensitive drum by a video signal and reproduces the image by transferring the latent image formed on the photosensitive drum onto a medium such as paper. Accordingly, the laser printer comprises a laser scanning unit having a laser diode for scanning the laser beam on the photosensitive drum and a controller for controlling the laser diode.

FIG. 1 illustrates an example of the structure of a conventional laser printer.

The shown laser printer comprises a photosensitive drum 10 having an electrically chargeable layer and generating an electric potential difference in the locations charged by the exposure of a light source, a charging unit 11 for charging the photosensitive drum 10, a laser scanning unit (LSU) 20 for forming an electrostatic latent image based on the electric potential difference by converting the electrical signal of image data to be formed into the optical signal and scanning the converted optical signal on the photosensitive drum 10, a developing unit 30 for sequentially supplying and developing the toner for providing colors to the photosensitive drum 10, a transfer unit 40 for transferring a toner image formed on the photosensitive drum 10 to a sheet (P), and a fixing unit 50 for affixing the transferred toner image onto the sheet (P).

The developing unit 30 includes four toner reservoirs 30a through 30d for sequentially supplying and developing the color toners comprising yellow (Y), magenta (M), cyan (C) and black (B) to the photosensitive drum 10. The color toners are stored in the four reservoirs 30a through 30d and supplied to the photosensitive drum 10 with the rotational movement. A reference numeral 30e denotes a developing roller for applying the yellow color toner to the photosensitive drum 10, the color toner reservoirs 30b through 30d also include the developing roller, respectively.

The transfer unit 40 includes a transfer belt 40a serving as a transport medium for the toner image formed on the photosensitive drum 10, a first transfer roller 40b for transferring the toner image on the photosensitive drum 10 to the transfer belt 40a, and a second transfer roller 40c for transferring the toner image on the transfer belt 40a to a sheet (P).

In the above-configured image forming apparatus, the laser beam is scanned on the photosensitive drum 10 which is charged to a constant potential by the charging unit 11, by the laser scanning unit (LSU) 20, resulting in the electric latent image being formed on the photosensitive drum 10.

Subsequently, the developing operation on the electrostatic latent image is performed by the developing unit 30, and at this time, typically, the developing operation is performed while each of the color toner reservoirs 30a through 30d is sequentially applied to the photosensitive drum 10 according to the rotation of the developing unit 30 in the order of yellow, magenta, cyan and black colors.

The visible color image formed on the photosensitive drum 10 with the above developing process is transferred overlapping to the transfer belt 40a, and the image on the transfer belt 40a is transferred to the sheet (P) passing between the transfer belt 40a and the second transfer roller 40c.

The sheet having the image transferred continuously passes through the fixing unit wherein the image is fixed on the printing sheet (P) and then discharged.

FIG. 2 is a sectional view illustrating the image forming structure of the laser beam incident on the photosensitive drum 10 from the laser scanning unit (LSU) 20, shown in FIG. 1.

The shown laser scanning unit (LSU) 20 comprises a laser diode 21, a deflection unit 22 for deflecting the beam emitted from the laser diode 21 into a desired direction, a F-theta lens unit 23 for adjusting the focal distance between the beam deflected from the deflection unit and the photosensitive drum 10, and a reflecting mirror 24 for changing the beam having the focal distance adjusted to the direction of the photosensitive drum 10. Herein, the laser diode 21 usually projects two or more beams to increase the amount of electrostatic latent images being formed on the photosensitive drum 10 per unit per hour. Typically, this is referred to as multi-beams and as the number of beams concurrently scanned on the photosensitive drum 10 increases, the electrostatic latent image which is formed on the photosensitive drum 10 per unit per hour increases. On the other hand, as shown, since the beam emitted from the laser scanning unit 20 is deflected by the reflecting mirror 24 and applied to the photosensitive drum 10, the beam emitted from the laser scanning unit 20 is not applied to the photosensitive drum 10 in a straight line. Assuming that the shown laser scanning unit 20 concurrently projects two beams, the beams line 1, line 2 deflected by the reflecting mirror 24 are applied to the photosensitive drum 10 with a prescribed incident angle β. Since the photosensitive drum 10 usually has a cylindrical shape, the beam line 1 is first incident on the photosensitive drum 10 as compared with the beam line 2. In other words, according to the geometric property between the photosensitive drum 10 and the beam line 1 and the beam line 2 emitted from the reflecting mirror 24, there is a difference in the straight distance between the photosensitive drum 10 and the two beams line 1 and line 2. When the laser scanning unit 20 scans the photosensitive drum 10 from one end thereof to the other end, the beams line 1 and line 2 scanned on the photosensitive drum 10 are not able to be scanned along the same perpendicular line.

FIG. 3 is a sectional view of an electrostatic latent image which is formed on the photosensitive drum 10 when viewing the photosensitive drum 10 shown in FIG. 2 from the direction “A”.

As shown, when two beams line 1 and line 2 are scanned on the photosensitive drum 10 per unit per hour, the image positions of the beam lines 1 and line 2 of the region “C” perpendicular to the laser scanning unit 20 are identical, while the image positions of the region “B” on the left end of the photosensitive drum 10 and the region “D” on the right end of the photosensitive drum 10 are deflected. In FIG. 3, the beam line 2 of the region “B” is inclined to the left relative to the beam line 1, and the beam line 2 of the region “D” is inclined to the right relative to the beam line 1. As described above, the reason why this occurs is that there is a difference between the distances that the beam lines 1 and line 2 arrive at the photosensitive drum 10, and also when the beam lines 1 and line 2 incline to the regions “B” and “D” of the photosensitive drum 10 about the region “C”, the beam lines 1 and line 2 scan the planar of the photosensitive drum 10, thereby incurring an error upon deflection of the beam lines 1, line 2 toward the regions “B” and “D”. That is, unless the photosensitive drum 10 has a crescent shape relative to the beam lines 1 and line 2 emitted from the laser scanning unit 20, there is a problem in that a scanning error occurs.

### SUMMARY OF THE INVENTION

In an effort to overcome the problems as mentioned above, it is an aspect of the present invention to provide a control apparatus and a method for correcting the trace of a beam which is emitted from a scanning unit of a laser printer.

An aspect of the present invention can substantially be accomplished by an apparatus for controlling a laser scanning unit which scans a plurality of beams on a photosensitive drum to form an electrostatic latent image corresponding to an image signal and is synchronized with each of a unit clock or pulse or cycle constituting a reference clock to scan the plurality of beams on the photosensitive drum. The apparatus comprises a first clock generating unit for dividing the reference clock signal according to a setting value applied externally to generate a first clock signal; a correction value calculating unit for dividing a section in which the electrostatic latent image is formed on the photosensitive drum into a predetermined number according to a section setting value applied externally, varying the number of the first clock signal assigned per unit clock of the divided respective sections, and calculating the clock frequencies of the respective sections based on the varied number of the first clock signal; and a second clock generating unit for generating for the respective sections a clock signal corresponding to the clock frequency calculated by the correction value calculating unit for the respective sections, to replace the generated clock signal with the reference clock signal.

The correction value calculating unit may include a section setting unit for counting the reference clock signal a predetermined number of times according to the section setting value and dividing a section in which the electrostatic latent image is formed on the photosensitive drum; a pixel clock calculating unit for dividing the number of the first clock signal on an entire section in which the electrostatic latent image is formed by the reference clock signal and calculating the number of the first clock signal assigned per unit clock of the respective sections; and a section frequency calculating unit for calculating a clock frequency based on the number of the first clock signal calculated per unit clock of the respective sections.

The setting value may be applied to the remaining beam except for any one standard beam of the plurality of beams concurrently scanned from the laser scanning unit onto the photosensitive drum.

The object of the present invention can substantially be accomplished by a method for controlling a laser scanning unit which scans a plurality of beams on a photosensitive drum to form an electrostatic latent image corresponding to an image signal and is synchronized with a reference clock signal to scan the plurality of beams. The method comprising the steps of dividing the reference clock according to a setting value applied from externally to generate first clock signal; dividing a section in which the electrostatic latent image is formed on the photosensitive drum into a predetermined number according to a section setting value applied externally, varying the number of the first clock signal assigned per unit clock of the divided respective sections, and calculating a clock frequency of the respective sections based on the varied number of the first clock signal; and generating for the respective sections a clock signal corresponding to the clock frequency calculated for the respective sections, to drive the laser scanning unit with the generated clock signal.

The step of calculating the clock frequency of the respective sections may comprise the step of counting the reference clock signal a predetermined number of times according to the section setting value and dividing a section in which the electrostatic latent image is formed on the photosensitive drum; dividing by the reference clock the number of the first clock signal on an entire section in which the electrostatic latent image is formed and calculating the number of the first clock signal assigned per unit clock of the respective sections; and calculating a clock frequency based on the number of the first clock signal calculated per unit clock of the respective sections.

The step of driving the laser scanning unit may further comprise the step of reading an image formed corresponding to the picture signal according to the driving result of the laser scanning unit, and then varying the setting value.

The setting value may be applied to the remaining beam except for any one standard beam of the plurality of beams concurrently scanned from the laser scanning unit onto the photosensitive drum.

The lengths of the respective sections divided by the section setting value may be equal to each other.

### BRIEF DESCRIPTION OF THE DRAWINGS

The above aspects and features of the present invention will be more apparent by describing certain embodiments of the present invention with reference to the accompanying drawings, in which:

FIG. 1 illustrates an example of a structure of a conventional laser printer;

FIG. 2 is a sectional view of the image-forming structure of laser beam incident on a photosensitive drum from the laser scanning unit as shown in FIG. 1;

FIG. 3 is a sectional view illustrating an electrostatic latent image which is formed on the photosensitive drum when viewing the photosensitive drum as shown in FIG. 2 from the direction of “A”;

FIGS. 4A and 4B are diagrams illustrating a method for controlling the laser scanning unit according to an embodiment of the present invention;

FIG. 5 is a block diagram illustrating an apparatus for controlling the laser scanning unit according to an embodiment of the present invention; and

FIG. 6 is a flowchart illustrating a method for controlling the laser scanning unit according to an embodiment of the present invention.

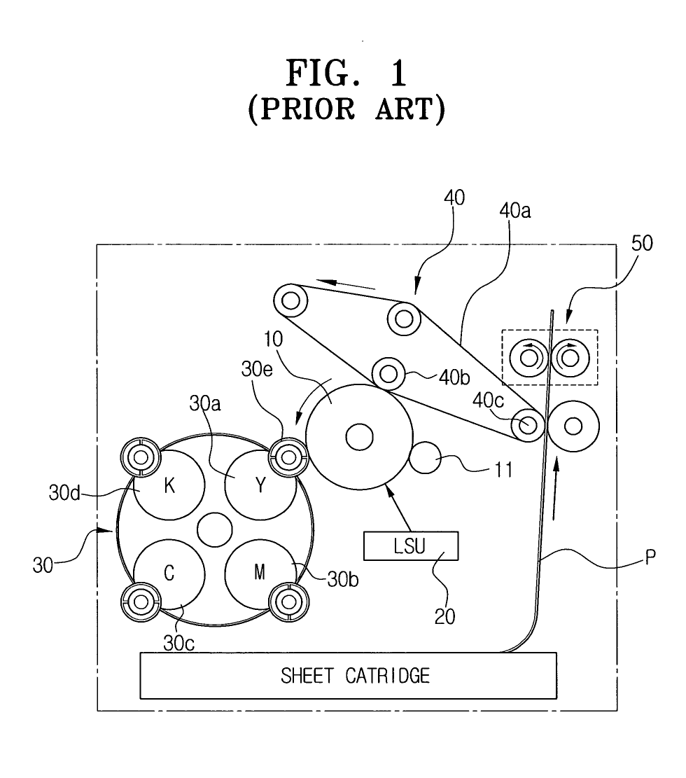

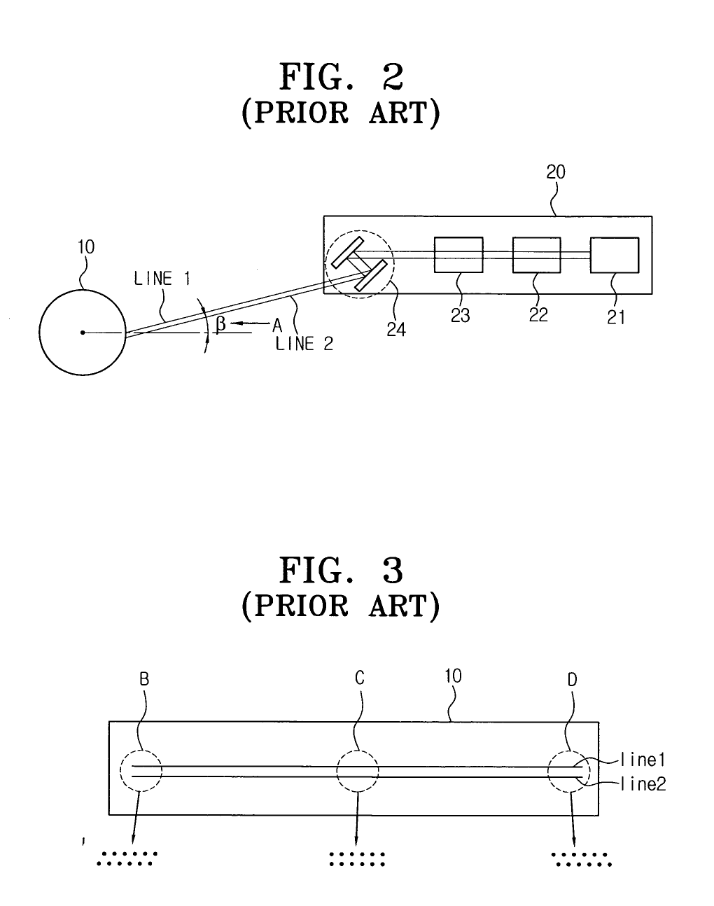

### DETAILED DESCRIPTION OF THE PREFERRED EMBODIMENTS

Certain embodiments of the present invention will be described in greater detail with reference to the accompanying drawings.

In the following description, the same drawing reference numerals are used for the same elements in different drawings. The matters defined in the description such as a detailed construction and elements are exemplary. Thus, it should be apparent that the present invention can be performed without the examples. Also, well-known functions or constructions are not described in detail since they would obscure the invention in unnecessary detail.

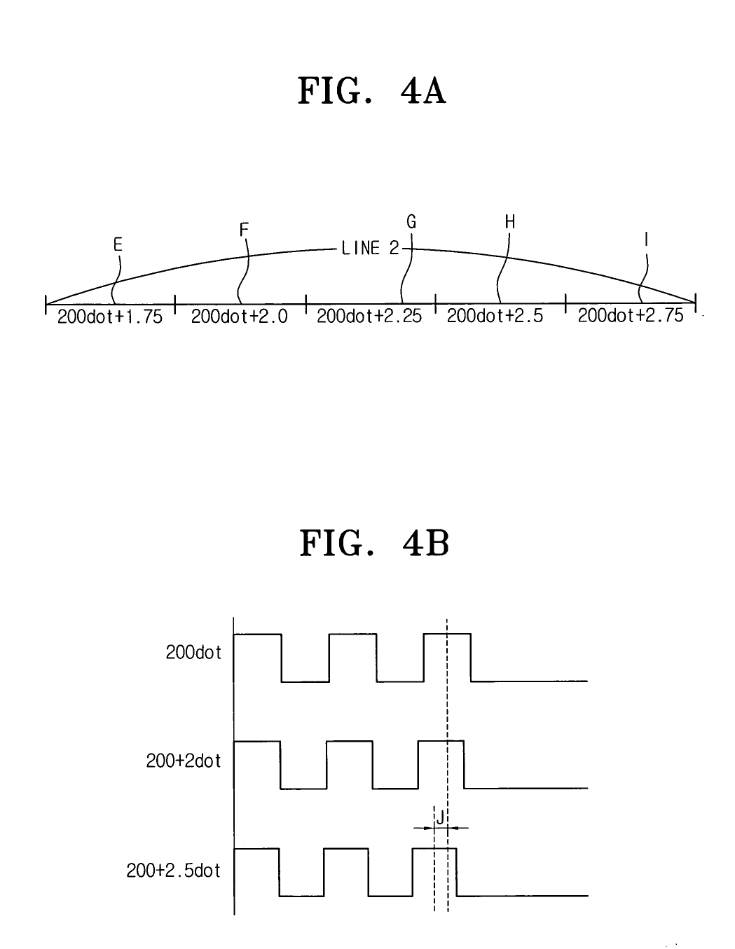

FIGS. 4A and 4B are diagrams illustrating a method for controlling the laser scanning unit according to one embodiment of the present invention.

FIG. 4A illustrates a section in which an electrostatic latent image is formed on the photosensitive drum by the beam line 2 and is divided into five sections E, F, G, H, and I, and the beam line 2 is scanned according to different frequencies for each section. Hereinafter, it is assumed that the section in which the electrostatic latent image is formed by the beam line 2 scanned in each of the sections E, F, G, H, and I has the resolution of 1000 dots.

Since the resolution of the section in which the electrostatic latent image is formed by the beam line 2 has 1000 dots, each of the divided sections E, F, G, H and I has the resolution of 200 dots. As described above, according to the geometric property of the photosensitive drum 10, there is generated an error in the electrostatic latent images formed by the beams line 1 and line 2 scanned on the surface of the photosensitive drum 10. The beams line 1 and line 2 scanned from the laser scanning unit 20 onto the photosensitive drum 10 are synchronized with a reference clock signal (not shown) which is supplied to the laser scanning unit 20 and have the structure for scanning each dot. According to one embodiment of the present invention, the reference clock signal is varied and clock signals having different frequencies for each section are applied, and therefore, the error of the electrostatic latent image formed on the photosensitive drum 10 is corrected. In the drawing, “200 dot+1.75” denoted in “E” region indicates that the reference clock is varied so that the latent image of 201.75 dot is formed on “E” region, and 200 dot+2.75 denoted in “I” region indicates that the reference clock is varied so that the latent image of 202.75 dot is formed on “I” region. The beam line 2 is shown in the drawing, which results from performing the scanning error correction according to one embodiment of the present invention based on the beam line 1.

Next, FIG. 4B illustrates the waveforms of the reference clock signal which is varied according to the concept explained in FIG. 4A.

As shown, assuming that the beam (for example, line 2) is scanned on the photosensitive drum 10 in the third clock pulse or cycle of the reference clock signal (200 dot) shown in the top of the drawing, the clock signal (200 dot+2.5) shown in the bottom of the drawing has the variation by “J” relative to the reference clock signal (200 dot). According to this, the latent image of the beam (for example, “H” region), which is scanned upon synchronizing the clock signal (200 dot+2.5), is formed on the left of the photosensitive drum 10 relative to the reference clock signal (200 dot). An embodiment of the present invention allows the correction of the scanning error of the beams line 1 and line 2 scanned on the photosensitive drum 10 due to such a clock signal variation.

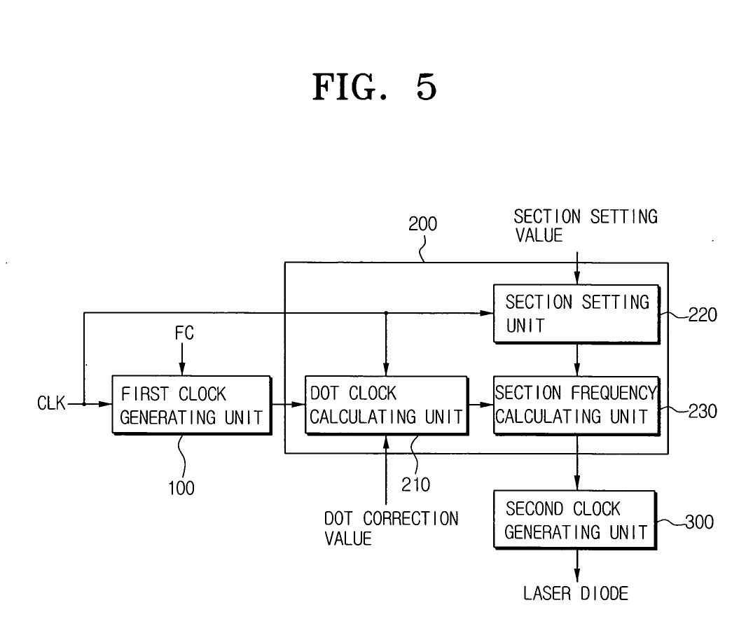

FIG. 5 is a block diagram illustrating an apparatus for controlling the laser scanning unit according to an embodiment of the present invention.

The control apparatus of the laser scanning unit shown comprises a first clock generating unit 100, a correction value calculating unit 200, and a second generating unit 300.

The first clock signal generating unit 100 divides the reference clock (clk) signal depending on a dot correcting value applied externally. At this time, the first clock generating unit 100 is applied with a chopping frequency (fc) to obtain a desired resolution and performs the chopping operation on each of a unit clock signal (e.g., clock pulse or cycle) constituting the reference clock (clk) signal. For example, assuming that the reference clock (clk) signal is 20 Mhz and the chopping frequency (fc) is 3.2 Ghz, the first clock signal generating unit 100 divides the chopping frequency (fc) of 3.2 Ghz by 20 Mhz to obtain the chopping clock signal of 160 cycles or unit clock cycles. In other words, each unit clock is represented by the chopping clock of 160 cycles.

The correction value calculating unit 200 divides into a prescribed number an entire section in which the electrostatic latent image is formed on the photosensitive drum depending on the section setting value applied externally, and varies the chopping clock signal on a unit clock of each of the divided sections (for example, E, F, G, H, and I sections) by reflecting the dot correction value. For example, the correction value calculating unit 200 allows for the number of dot clocks per clock to be about 150-200. After this, the correction value calculating unit 200 counts the number of the dot clocks included in the section on which the dot correction value is reflected, and calculates the frequency of the section on which the dot correction value is reflected based on the counted dot clock.

When the beam line 2 is scanned on each section (E, F, G, H, and I) according to the frequency calculated by the correction value calculating unit 200, the second clock generating unit 300 generates clock signals of different frequencies for each section and applies them to the laser diode 21. The beam line 2 is generated and emitted by the laser diode 21 included in the laser scanning unit 20 while synchronizing with the clock outputted from the second clock generating unit 300.

The correction value calculating unit 200 may have a dot clock calculating unit 210, a section setting unit 220, and a section frequency calculating unit 230.

The dot clock calculating unit 210 varies the dot clocks applied from the first clock generating unit 100 by reflecting the dot correction value. The dot correction value is independently given for the each section (E, F, G, H, and I). Based on this, the dot clock calculating unit 210 calculates the number of the dot clocks assigned per unit clock of each section.

The section setting unit 220 counts the reference clock (clk) signals a predetermined number of times depending on the section setting value and divides the section in which the electrostatic latent image is formed on the photosensitive drum. For example, if the section setting value is given with “5”, the section in which the electrostatic latent image is formed by the beam line 2 is equally divided into fives (referring to FIG. 4A).

The section frequency calculating unit 230 calculates the frequency in each section, based on the dot clocks on a unit clock of each section set by the section setting unit 220. In other words, the clock frequency of each section (E, F, G, H, and I) shown in FIG. 4A has values different from each other.

The description of an example on the operation of the correction value calculating unit 200 is as follows.

Prior to the description, it is assumed that the reference clock (clk) signal is 20 Mhz, the chopping frequency is 3.2 Ghz, a section setting value is 5, dot correction value for the section “G” is 2.25, and each of the sections (E, F, G, H, and I) has a resolution of 200 dots.

First, the first clock generating unit 100 divides the chopping frequency by the reference clock (clk). In other words, 3.2 Ghz/20 Mhz=160, each of a unit clock constituting the reference clock (clk) comprises 160 dot clocks. Then, the dot clock calculation unit 210 sets the resolution of the section “G” to 202.25 by adding the dot correction value 2.25 to the resolution of 200 dots, and calculates the number of the dot clocks constituting the set resolution. Since the dot clock of a unit clock is set to 160, the number of the dot clocks included in the section “G” becomes (202.25×160), i.e., 32,360. The section frequency calculating unit 230 calculates the number of the dot clocks of each dot included in the section “G” added with the dot correction value. At this time, the number of the dot clocks calculated becomes 161.8 by dividing 32360 calculated by the dot clock calculation unit 210 by 200 dots. In other words, the number of the dot clocks included in the section “G” increases, and the clock frequency of the section “G” increases. At this time, when calculating the frequency of the section “G” based on the dot clock 161.8 of each dot included in the section “G”, becomes 20.1 Mhz.

On the other hand, the number of the dot clocks 161.8 of each dot calculated in the section “G” has a value of 0.8 below a decimal point. It is not easy to control the dot by 0.8 clocks using the value below a decimal point. If the value is discarded or rounded up, it is possible to generate an error in the operation on the dot clock in the sections “H” and “I” next to the section “G”. Thus, if the value below a decimal point is included in the dot clock value of the respective dots calculated in the respective sections, the value is transferred to a section next to that section (for example, the section “H”), and when calculating the dot clock per a dot of the section “H”, the dot clock including the transferred value is calculated.

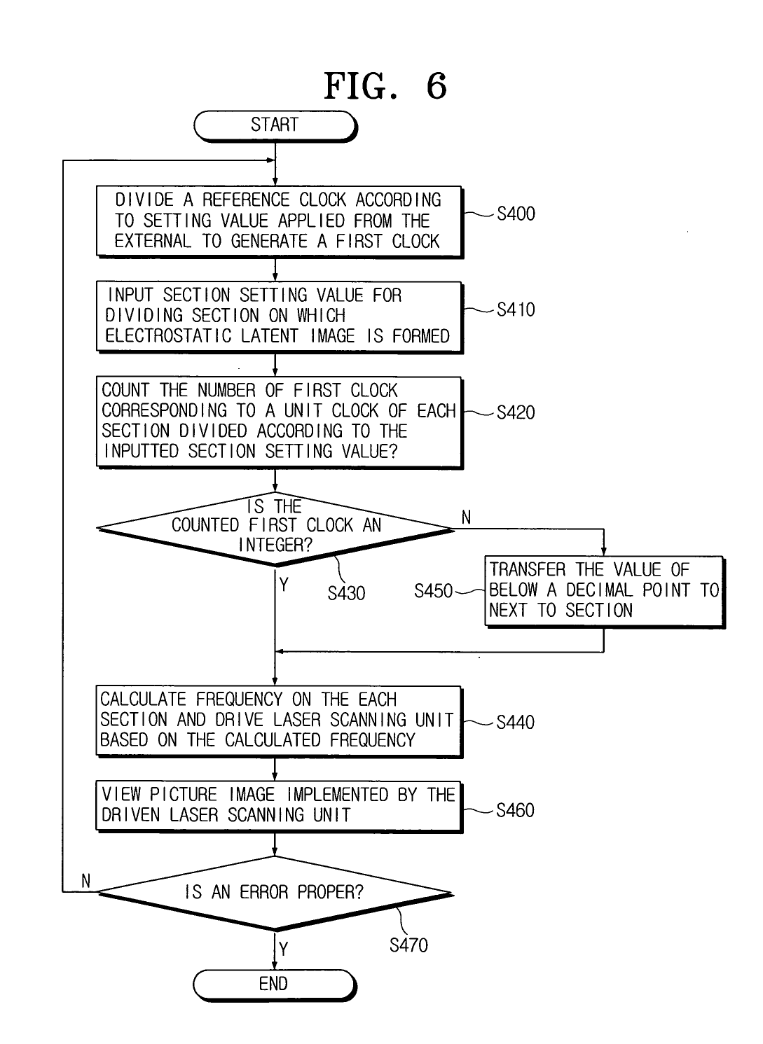

FIG. 6 illustrates a flowchart according to one certain of the laser scanning unit according to an embodiment of the present invention.

The first clock generating unit 100 divides the chopping frequency (fc) applied externally by the reference clock signal to represent each of a unit clock comprising the reference clock (clk) signals by a predetermined number of the dot clocks at step S400. Then, the section setting unit 200, based on the section setting value provided externally by a user of the laser printer, or a designer and manufacturer of the laser printer, divides the section in which the electrostatic latent image is formed into a predetermined number (for example, fives) using the remaining beam (for example, line 2) except for a standard beam (line 1) of a plurality of beams (for example, line 1 and line 2) scanned onto the photosensitive drum 10 as shown in FIG. 4A at step S410. Next, the number of the dot clock is counted for the divided respective sections (E, F, G, H, and I) at step S420. The count of the dot clock is performed by varying the number of the dot clocks for the reference clock (clk) signal and resetting the clock frequency for the respective sections based on the varied number of the dot clocks. At this time, it is determined whether the counted clock signal is an integer at step S430, and if not an integer, i.e., if having the value below a decimal point, the clock frequency is calculated by transferring the value to the next section at step 450; otherwise, the clock frequencies for the respective sections are calculated by applying the dot correction value of the real number range for the respective sections, and based on this, the laser scanning unit 20 is driven at step 440. The laser diode (not shown) included in the laser scanning unit 20 is synchronized with the clock frequency calculated for the respective sections, resulting in the electrostatic latent image being formed on the photosensitive drum 10. Subsequently, the user, designer and manufacturer of the laser printer can view the picture image reproduced by the electrostatic latent image formed on the photosensitive drum 10 at step S460. As a result of the observation, if the error of the pixel constituting the picture image is proper, the correction is completed at step 470; if not, the process feedbacks to the step (S400).

As described in the above, the embodiments of the present invention can improve the printing quality of the image forming apparatus comprising the laser scanning unit by minimizing the error of the electrostatic latent image which is formed by the beam scanned from the laser scanning unit to the photosensitive drum.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An apparatus for controlling a laser scanning unit which scans a plurality of beams on a photosensitive drum to form an electrostatic latent image corresponding to an image signal and is synchronized with each of a unit clock signal comprising a reference clock signal for scanning the plurality of beams on the photosensitive drum, comprising:
a first clock signal generating unit for dividing the reference clock signal according to a setting value applied externally to generate a first clock signal;
a correction value calculating unit for dividing a section in which the electrostatic latent image is formed on the photosensitive drum into a predetermined number according to a section setting value applied externally, varying the number of the first clock signal assigned per unit clock of the divided respective sections, and calculating the clock frequencies of the respective sections based on the varied number of the first clock signal; and
a second clock signal generating unit for generating for the respective sections a clock signal corresponding to the clock frequency calculated by the correction value calculating unit for the respective sections, to replace the generated clock with the reference clock.

2. The apparatus of claim 1, wherein the correction value calculating unit comprises:
a section setting unit for counting the reference clock signal to a predetermined number according to the section setting value and dividing a section in which the electrostatic latent image is formed on the photosensitive drum;
a pixel clock calculating unit for dividing the number of the first clock signal on an entire section in which the electrostatic latent image is formed by the reference clock signal and calculating the number of the first clock signal assigned per unit clock of the respective sections; and
a section frequency calculating unit for calculating a clock frequency based on the number of the first clock signal calculated per unit clock of the respective sections.

3. The apparatus of claim 1, wherein the setting value is applied to the remaining beam except for any one standard beam of the plurality of beams concurrently scanned from the laser scanning unit onto the photosensitive drum.

4. A method for controlling a laser scanning unit which scans a plurality of beams on a photosensitive drum to form an electrostatic latent image corresponding to an image signal and is synchronized with a reference clock signal for scanning the plurality of beams, comprising the steps of:
dividing the reference clock signal according to a setting value applied externally to generate a first clock signal;
dividing a section in which the electrostatic latent image is formed on the photosensitive drum into a predetermined number according to a section setting value applied externally, varying the number of the first clock signal assigned per unit clock of the divided respective sections, and calculating a clock frequency of the respective sections based on the varied number of the first clock signal; and
generating for the respective sections a clock signal corresponding to the clock frequency calculated for the respective sections, for driving the laser scanning unit with the generated clock.

5. The method of claim 4, wherein the step of calculating the clock frequency of the respective sections comprises the step of:
counting the reference clock signal to a predetermined number according to the section setting value and dividing a section in which the electrostatic latent image is formed on the photosensitive drum;
dividing by the reference clock signal the number of the first clock signal on an entire section in which the electrostatic latent image is formed and calculating the number of the first clock signal assigned per unit clock of the respective sections; and
calculating a clock frequency based on the number of the first clock calculated per a unit clock of the respective sections.

6. The method of claim 4, wherein the step of driving the laser scanning unit further comprises the step of reading an image formed corresponding to the picture signal according to the driving result of the laser scanning unit, and then varying the setting value.

7. The method of claim 4, wherein the setting value is applied to the remaining beam except for any one standard beam of the plurality of beams concurrently scanned from the laser scanning unit onto the photosensitive drum.

8. The method of claim 4, wherein the lengths of the respective sections divided by the section setting value are equal.
